(19) United States
(12) Patent Application Publication
(10) Pub. No.: US 2004/0018311 A1
(43) Pub. Date: Jan. 29, 2004

(54) Coating powders, methods for coating articles with the same, and articles derived therefrom

(76) Inventors: Navin B. Shah, Sinking Spring, PA (US); Charles P. Tarnoski, Sinking Spring, PA (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/615,685

(22) Filed: Jul. 9, 2003

Related U.S. Application Data
(60) Provisional application No. 60/399,172, filed on Jul. 29, 2002.

(51) Int. Cl. B05D 3/02

(52) U.S. Cl. 427/385.5

(57) ABSTRACT

The polyester resin based coating powders described herein contain semi-crystalline polyester resins and amorphous polyester resins formed from polyols and polyacids. The polyester resin based coating powders are curable at low cure temperatures in short time periods, and impart excellent gloss and mechanical properties

### BACKGROUND

The present invention relates to coating powders, methods for coating an article, and articles derived therefrom.

Coating powders are dry, finely divided, free-flowing solid materials at room temperature. They are conveniently applied using electrostatic methods, wherein an electric potential is generated between the coating powder and the substrate to be coated, causing the powder particles to be attracted to the substrate. Coating powders find particular utility in industrial coating applications because they are readily applied to a variety of conductive substrates, they use very little (or no) organic solvents, and excess coating powders can be readily recycled.

U.S. Pat. No. 6,184,311 discloses a thermosetting coating powder composition comprising as a binder a co-reactable particulate mixture of a carboxylic acid-functional polyester component and a curing agent having groups reactive with carboxylic acid groups, characterized in that the carboxylic acid-functional component comprises a semi-crystalline polyester having an acid value of 10-70 mg KOH/g and a hydroxy value of no more than 11 mg KOH/g. Generally the semi-crystalline polyester has one or more T_{g} values less than 55° C., a sharp melting point of 50 to 200° C. and preferably a number average molecular weight of at least 1600. The composition may, if desired, include an amorphous polyester and the curing agent may be, for example, an epoxy resin or a bis(beta-hydroxyalkylamide).

Although the semi-crystalline polyester based coating powders of U.S. Pat. No. 6,184,311 reportedly exhibited excellent flow and mechanical properties, the coating powders required on average 10 to 30 minutes at cure temperatures of 160° C. (320° F.) to 200° C. (392° F.) to form the powder coatings. Such cure times are disadvantageous in commercial coating processes, which require high throughput to be economical. We have now found that a coating powder can be cured at a lower temperature in a shorter amount of time, forming a smooth, flexible coating by using a particular combination of an amorphous polyester resin and a semi-crystalline polyester resin.

### STATEMENT OF THE INVENTION

In a first aspect, there is provided a coating powder comprising a polyester resin composition comprising an amorphous carboxylic acid functional polyester resin in an amount of 75 to 90 parts per hundred of the resin composition by weight, and a semi-crystalline polyester resin in an amount of 10 to 25 parts per hundred of the resin composition by weight; an epoxy-functional compound; and a catalyst.

In a second aspect, there is provided a coating powder comprising a polyester resin composition comprising an amorphous carboxylic acid functional polyester resin in an amount of 75 to 90 parts per hundred of the resin composition by weight, and a semi-crystalline polyester resin in an amount of 10 to 25 parts per hundred of the resin composition by weight, wherein the semicrystalline resin is formed from a polyol and a polycarboxylic acid, wherein the polycarboxylic acid comprises 10 to 50 phr of an asymmetrically substituted aromatic polyacid or derivative thereof; an epoxy-functional compound; and a catalyst.

In another aspect, there is provided a method for coating an article comprising contacting the article with a layer of the particulate coating powder described above; fusing the coating powder layer to form a powder coating; and curing the powder coating at a temperature and for a time effective to form a smooth coating.

In another aspect, there is provided a coating powder formed by cure of a fused coating powder composition comprising a polyester resin comprising an amorphous carboxylic acid functional polyester resin in an amount of 75 to 90 parts per hundred of the resin composition by weight, and a semi-crystalline polyester resin in an amount of 10 to 25 parts per hundred of the resin composition by weight; an epoxy-functional compound; and a catalyst.

### DETAILED DESCRIPTION

The polyester resin comprises an amorphous carboxylic acid functional polyester resin and at least one semi-crystalline polyester resin. Suitable carboxylic acid functional polyester resins are linear or branched, and formed by the polymerization of polyols and poly-functional carboxylic acids. Examples of suitable polyols for forming the carboxylic acid functional polyester resin include 1,2-ethanediol, 1,3-propanediol, 1,4-butanediol, 1,6-hexanediol, 1,10-decanediol, 1,12-dodecanediol, 1,4-cyclohexanedirnethanol, diethylene glycol, triethylene glycol, neopentyl glycol, trimethylolpropane, hydrogenated bisphenol A (2,2-(dicyclohexanol)propane), 2,2,4-trimethyl-1,3-pentanediol, 2-methyl-1,3-propanediol, 2-methyl-2-hydroxymethyl-1,3-propanediol,2-ethyl-2-hydroxymethyl-1,3-propanediol, combinations comprising at least one of the foregoing polyols, and the like.

Examples of suitable poly-functional carboxylic acids include succinic acid, adipic acid, azelaic acid, sebacic acid, 1,12-dodecanedioic acid, terephthalic acid, isophthalic acid, phthalic acid, trimesic acid, tetrahydrophthalic acid, hexahydrophthalic acid, 1,4-cyclohexanedicarboxylic acid, 1,3-cyclohexanedicarboxylic acid, trimellitic acid, naphthalene dicarboxylic acid, and the like, and combinations comprising at least one of the foregoing poly-functional carboxylic acids. The corresponding acid halides, esters, or anhydrides of the aforementioned acids may also be used, for example, tetrahydrophthalic anhydride, hexahydrophthalic anhydride, trimellitic anhydride, phthalic anhydride, and the like.

Many prior art epoxy-cured polyester coating powders, particularly those containing polyesters based primarily on neopentyl glycol and terephthalic acid suffer from the undesirable phenomenon called “blooming” when cured at temperatures of 350° F. or lower. The blooming effect also becomes evident when an object coated with such a coating powder is kept for a sufficient length of time at a temperature above the glass transition temperature of the coating. The bloom appears as a whitish patina on the surface. Evidence exists that the blooming in epoxy-cured polyester coatings is a result of migration of cyclic oligomers to the surface. Cyclic oligomers do not enter into the curing reaction and tend to migrate to the surface, or “bloom” from the cured coating. Thus by reducing the formation of such cyclic oligomers, blooming in the powder coating can be reduced or eliminated. (“Cyclic oligomers in saturated polyesters” by L. Bhopal, H. Osterholm, H. Jarvinen, L. Pietila, POLYMER, 41 (23) 8283-8290, November 2000; “Determination of the chemical nature of the “blooming” effect in polyester based powder coatings” F. Martinazzo, G. Brocca, R. Cavalieri, A. Martina; JOCCA-Surface Coatings International, 78(7) U7-U10; July 1995).

Conventional amorphous polyester resins used in coating powders incorporate high levels of polyfunctional carboxylic acids, specifically isophthalic acid, e.g. 25 to 75% by weight based on the total weight of the amorphous polyester resin, to obtain a non-blooming resin. Applicants employ suitable monomers in addition to or in place of isophthalic acid to produce the amorphous carboxylic acid functional polyester resin, a non-blooming resin as disclosed in U.S. Pat. No. 5,880,223. As a result, the amorphous carboxylic acid functional polyester resin contains no more than 20 mole percent of isophthalic acid. Suitable monomers include from 2 to 25 mole percent, preferable from 3 to 25 mole percent of the hydroxyl functionality relative to total hydroxyl functionality of the monomers and polyols used to from the amorphous carboxylic acid functional polyester resin. A preferred monomer is 2-n-butyl-2-ethyl-1,3-propanediol (BEPD, CAS#115-84-4). It is found that the incorporation of this monomer at such levels reduces blooming in the cured powder coatings. While the applicant is not bound by theory, it is believed that the inclusion of BEPD in the polyester substantially reduces for eliminates the formation of low molecular weight cyclic oligomers.

In the amorphous carboxylic acid functional polyester resin, carboxylic functionality is provided in excess over hydroxyl functionality, whereby the polyester chains are carboxyl terminated. Preferably, these polyester chains are relatively short having acid numbers from 15 to 100, preferably from 25 to 90. The preferred glass transition temperatures (T_{g}) of the polyester resin are greater than or equal to 40 degrees Celsius (° C.), preferably greater than or equal to 50° C., and less than or equal to 75° C., preferably less than or equal to 65° C. The preferred weight average molecular weights of the polyester resins are from 2000 to 5000. The polyester resins are amorphous. Suitable amorphous polyester resins are a general purpose polyester resin employed in coating powders, a captive resin of, Rohm and Haas, Philadelphia, Pennsylvania, in which the resulting powder coating exhibits a heavy orange peel when cured at 300° F. for 10 minutes; and a non-blooming amorphous polyester resin employed in coating powders, which is also a captive resin of Rohm and Haas, that produces smoother powder coatings without experiencing as much blooming at low cure temperatures.

Semi-crystalline polymers generally exhibit a heterogeneous morphology, i.e., crystalline and amorphous phases. They are typically opaque and white at ambient temperatures, have a high degree of structural regularity, i.e., chemical, geometrical, and/or spatial geometry, and enhance the flexibility of the resulting coating powder. More importantly, adding a semi-crystalline resin to the coating powder reduces the coating powder's overall melt viscosity. As a result, once the coating powder is applied, fused, and cured, the resulting powder coating possesses a smoother, more flexible coating than a powder coating produced without the inclusion of semi-crystalline resins, which will be illustrated in the Examples that follow.

More particularly, suitable semi-crystalline polyester resins possess an onset of melt temperature of greater than or equal to 45° C., preferably greater than or equal to 55° C., and less than or equal to 120° C., preferably less than or equal to 90° C. The semi-crystalline polyester resin preferably exhibits one or more T_{g} values of less than 55° C. A preferred melting point of the semi-crystalline polyester resin is greater than or equal to 50° C., preferably greater than or equal to 60° C, and less than or equal to 200° C., preferably less than or equal to 130° C. A preferred acid value of the polyester resin is from 10 to 250 milligrams (mg) KOH per gram. A preferred hydroxy number of the semi-crystalline polyester resin is no greater than 11 mg KOH per gram. The preferred number average molecular weight of the semi-crystalline polyester resin is greater than or equal to 600, preferably greater than or equal to 1000, and less than or equal to 20,000, preferably less than or equal to 2000. Preferably, the enthalpy of crystalline melting (ΔH) of the semi-crystalline polyester resin is from 20 to 300 Joules per gram (J/gm), preferably from 20 to 200 J/gm.

The semi-crystalline polyester resin is preferably formed by a polycondensation reaction of polyols with polycarboxylic acids or anhydrides, esters or acid chlorides based on these acids, using an excess of acid over alcohol so as to form a polyester resin with an acid number of greater than or equal to 10, preferably greater than or equal to 60, and less than or equal to 250, preferably less than or equal to 90, and with a hydroxyl number preferably no greater than 11.

To provide the desired flexibility of the resulting powder coating, greater than or equal to 90 parts per hundred parts by weight (phr) of the total weight of the polyol used to form the semi-crystalline polyester resin is a linear diol, and preferably 100 phr of the total polyol is a linear diol. Minor amounts, e.g., no greater than 10 phr of the polyol content may be other polyols. In addition, it has unexpectedly been found that advantageous properties may be obtained where greater than or equal to 10 phr, preferably greater than or equal to 20 phr of the total weight of the polycarboxylic acid used to form the semi-crystalline polyester resin is an asymmetrically substituted aromatic polyacid or derivative thereof, e.g., isophthalic acid, trimellitic anhydride, or a combination thereof. Less than or equal to 40 phr, less than or equal to 30 phr, or less than or equal to 25 phr of the total weight of the polycarboxylic acid used to form the semi-crystalline polyester resin is an asymmetrically substituted aromatic polyacid or derivative thereof. More particularly, suitable polyols are linear diols and suitable poly-functional carboxylic acids are aromatic diacids. For example, and as illustrated in the Examples that follow, 1,6-hexanediol is combined with terephthalic acid and isophthalic acid to form the semi-crystalline polyester resin, and in two other formulations, isophthalic acid is substituted in whole with trimellitic anhydride to form the semi-crystalline polyester resin.

An epoxy-functional compound is also present in the composition as a curing agent, such that the stoichiometric ratio of the epoxy functionality of the epoxy-functional compound to the carboxylic acid functionality of the amorphous carboxylic acid functional polyester resin is preferably from 0.7 to 1.3, more preferably from 0.8 to 1.2. The epoxy-functional compounds have epoxy functionalities of at least 2, preferably at least 3, and up to 16. Suitable epoxy-functional compounds include heterocyclic polyepoxides having two or more epoxides, such as triglycidylisocyanurate (TGIC); polyepoxides of aromatic polyols such as the diglycidyl ether of 2,2-bis(4-hydroxylphenyl)propane (bisphenol A), bisphenol F, and tetrabromobisphenol A, and the like; low molecular weight polymers derived from the foregoing aromatic polyols and their diglycidyl ethers; cycloaliphatic polyepoxides, such as 3′,4′-epoxycyclohexylmethyl 3,4-epoxycyclohexylcarboxylate, dicyclopentadiene dioxide, and the like; glycidyl esters of aromatic or aliphatic polyacids, such as the diglycidyl ester of hexahydrophthalic acid; low equivalent weight epoxy-functional acrylic resins; polyepoxides of aliphatic polyols such as the diglycidyl ether of 1,4-butanediol; and polyepoxides of amino-alcohols, such as the tri-glycidyl ether-amine of 4-amino phenol.

Preferred epoxy-functional compounds for low temperature cure compositions include glycidyl esters of aromatic and aliphatic polyacids, for example glycidyl esters of polyacids such as terephthalic, isophthalic, phthalic, methylterephthalic, trimellitic, pyromellitic, adipic, sebacic, succinic, maleic, fumaric, tetrahydrophthalic, methyltetrahydrophthalic, hexahydrophthalic, and methylhexahydrophthalic acid. These acids may be copolymerized with other alpha, beta-ethylenically unsaturated monomers, for example esters of acrylic acid or methacrylic acid, such as methyl, ethyl, hexyl, 2-ethoxy ethyl, t-butyl, 2-hydroxyethyl, and 2,2-di(p-hydroxy)phenyl esters, and the like; styrene; substituted styrene such as alpha-methyl styrene; and vinyl esters, such as vinyl acrylate and vinyl methacrylate.

The catalyst for the coating powder acts as a cure accelerator, and is present in an amount effective to enable the coating powder to achieve a “full cure” at low cure temperatures. A “full cure” is a degree of curing achieved at which additional time at elevated temperatures will not improve the properties of the powder coating once cooled to ambient temperatures. The catalyst is generally present in an amount of greater than or equal to 0.01 phr, preferably greater than or equal to 0.05 phr, most preferably greater than or equal to 0.1 phr per one hundred parts of the coating powder, and less than or equal to 10 phr, preferably less than or equal to 5 phr, most preferably less than or equal to 2 phr per one hundred parts of the coating powder. Suitable catalysts, or cure accelerators, may include a tetra-substituted ammonium halide salt, a tetra-substituted phosphonium halide salt, e.g., an alkyl triaryl phosphonium halide such as ethyl triphenyl phosphonium bromide; a tetra-substituted phosphonium, tetra-substituted arsonium, or tetra-substituted ammonium tetra-substituted borate salt, an imidazole tetra-substituted borate, or a mixture comprising at least one of the foregoing salts. The substituents may be independently Cl, Br, F, alkyl groups, or alkenyl groups, aryl groups, or substituted phenyl groups, each having from one to about 36 carbon atoms. In addition, the imidazole may comprise as substituents a hydrogen atom, acyl groups, aryl groups, cycloalkyl groups, cycloalkenyl groups, aldehyde groups, carboxyl groups, cyano groups, nitro groups, or a combination comprising at least one of the foregoing groups.

The composition may optionally comprise one or more additives known in the art. Such additives include, for example, flow control agents, dry flow agents, antioxidants, pigments, optical brighteners, extenders, light stabilizers, antioxidants, and the like, including combinations comprising at least one of the foregoing additives.

Flow control agents, sometimes called leveling agents, are useful to promote the formation of a continuous powder coating. Suitable flow control agents include polyacrylic esters, non-ionic fluorinated alkyl ester surfactants, non-ionic alkylarylpolyether alcohols, silicones, and the like. Flow control agents are generally liquids that have been converted to powder form by absorption onto inert carrier materials. A preferred flow control agent is an acrylic copolymer sold under the tradename RESIFLOW® P-67 by Estron Chemical, Inc.; the MODAFLOW® poly(alkyl acrylate) products commercially available from Monsanto; and, the SURFYNOL® acetylenic diols (e.g., P200), commercially available from Air Products, which contain hydroxyl, carboxyl or other functional groups; and a 2-hydroxy-1,2-diphenylethanone (2-hydroxy-2-phenylacetophenone, benzoin) crystalline solid sold from DSM, Inc. The flow control agents may be used individually or in combination. When present, the flow control agent may be used at an amount of 1 to 5 parts by weight per one hundred parts of the coating powder composition.

Suitable dry flow agents include fumed silica (for example, that sold under the tradename CAB-O-SIL® by Cabot Corporation) and fumed alumina (for example, that sold under the tradename Aluminum Oxide C by Degussa Corporation). When present, the dry flow agent may be used in an amount of 0.05 to 0.5 parts by weight per one hundred parts of the coating powder composition.

Pigments may be used to adjust color and opacity. Suitable pigments include, for example, titanium dioxide, carbon black, phthalocyanine blue, phthalocyanine green, quinacridone red, perylene red, isoindolone yellow, dioxazine violet, scarlet 3B lake, red 188 azo red, azo pigment yellow 83, iron oxide pigments, combinations comprising at least one of the foregoing, and the like. When present, the pigment may be used in an amount of up to 100 parts by weight per one hundred parts of the coating powder composition.

Suitable extenders/fillers include calcium carbonate, barium sulfate, dolomite, wollastonite, talc, mica, and the like. When present, the extender may be used in an amount of 10 to 120, preferably to 80 parts by weight per one hundred parts of the coating powder composition.

Suitable antioxidants, which prevent discoloration of the powder coating, include, for example, sodium hypophosphite, tris-(2,4-di-t-butyl phenyl) phosphite (available as IRGAFOS® 168 from Ciba-Geigy), calcium bis([monoethyl(3,5-di-t-butyl-4-hydroxybenzyl)phosphonate] (available as IRGANOX® 1425 from Ciba-Geigy), and the like. Mixtures of antioxidants may be used. When present, antioxidants may be used in an amount of 0.5 to 2.0 parts by weight per one hundred parts of the coating powder composition.

Suitable optical brighteners include, for example, 2,2′-(2,5-thiophenediyl)bis(5-t-butylbenzoxazole), available as UVITEX® OB from Ciba-Geigy. When present, optical brighteners may be present at 0.1 to 0.5 parts by weight per one hundred parts of the coating powder composition.

Suitable light stabilizers include, for example, substituted benzotriazoles such as TINUVIN 328, available from Ciba Geigy Corp. Antioxidants are also known, for example hindered phenols such as IRGANOX 1010 from Ciba Geigy Corp.

There is no particular limitation on the method used for forming the curable coating powder. Preferred methods include melt mixing, in which the dry ingredients are weighed into a batch mixer and are mixed with a medium intensity horizontal plowmixer or a lesser intensity tumble mixer. Mixing times may be from 1 to 3 minutes for the high intensity mixers, and from 30 to 60 minutes for the tumble mixers. The premix may then be further mixed and compounded as the resin is melted in either a single screw or a twin screw extruder for 0.5 to 1 minute. The extrudate may be cooled quickly and broken into small chips suitable for grinding. The chips are ground to an appropriate particle size, generally 20 to 120 micrometers, preferably 30 to 80 micrometers.

The curable coating powder may be used in coating glass, ceramics, and graphite-filled composites, as well as metallic substrates such as steel and aluminum. The composition is particularly useful in the coating of heat sensitive substrates such as plastics, paper, cardboard, and woods. Wood is herein defined as any lignocellulosic material, whether it comes from trees or other plants, and whether it be in its natural forms, shaped in a saw mill, separated into sheets and made into plywood, or chipped and made into particleboard, or whether its fibers have been separated, felted, or compressed. Other heat sensitive substrates include plastics, such as acrylonitrile butadiene styrene polymer resins (ABS), polyphenylene ether resins (PPO), sheet molded compounds (SMC), polyolefins, polycarbonates, acrylics, nylons and other copolymers which usually will warp or outgas when coated and heated with traditional heat curable coating powders. Optionally, these substrates may be filled or primed with ultraviolet radiation curable liquids, powder primers, or solvent or waterborne coatings to improve smoothness and reduce the required film buildups.

For example, a porous substrate such as particleboard, pre-coated with a conductive liquid coating composition and cured, may serve as a substrate for the coating powder. It is exemplified by lumber, panels, molding, siding, oriented strand board, hardboard, medium density fiberboard (MDF), and the like. Fiberboard having a pattern such as a simulated wood grain printed on its surface, rather than on a paper laminated to that surface, and a coating powder of this invention over said pattern has the appearance of natural wood. MDF is a particularly valuable coating substrate. Substrates may preferably have a moisture content of 3 to 10% by weight of the substrate. In addition, the substrate may be treated to enhance its electrical conductivity. The curable coating powder is also useful for coating plastic parts for the interior and exterior of automobiles.

The coating powder may be applied to substrates by conventional means, including electrostatic fluidized beds, electrostatic spray guns, triboelectric guns, and the like, in which the powder coating particles are electrostatically charged and the substrate is grounded or oppositely charged. The substrate is heated (and may optionally be pre-heated prior to its application), to aid the melt, flow, and coalescence of the particles. Coating powders are generally applied to achieve a coating thickness of 1.0 mil (0.0245 millimeters, “mm”) to 25 mils (0.635 mm), preferably at least 1.5 to 4 mils (0.038 to 0.102 mm).

After application to the substrate, the applied coating powder layer is cured, generally at a temperature of 200 to 500° F. (93 to 260° C.), preferably 220 to 450° F. (104 to 232° C.), more preferably 250 to 400° F. (121 to 204° C.). Where low curing temperatures are desired, for example with wood substrates cure is generally less than 325° F. (163° C.), more preferably less than 300° F. (149° C.), even more preferably less than 250° F. (121° C.). Another advantage of the curable powder coating composition is their ability to produce matte and low gloss finishes over a wide range of low curing temperatures. For example, such finishes may be produced over the entire temperature range of 300° to 400° F. (149 to 204° C.), more preferably 250° F. to 400° F. (121 to 204° C.).

The invention is further illustrated by the following examples.

All components were obtained commercially as shown in Table 1 below.

TABLE 1

| Trade Name | Source | Description |
|---|---|---|
| Benzoin M | DSM | 2-Hydroxy-2-phenylacetophenone |
| Fascat 4100 | Atofina | Organotin based trans-esterification |
| | Chemicals | catalyst, containing 60-100% hydrated |
| | | monobutyltin oxide |
| Irganox 1010 | Ciba Specialty | Tetrakis-(methylene-(3,5-di-(tert)-butyl-4- |
| | Chemicals | hydrocinnamate))-methane (GAS No. |
| | | 6683-19-8) |
| N/A | Rohm and Haas | Carboxyl terminated polyester; acid |
| | | number = 30-35 |
| N/A | Rohm and Haas | Carboxyl terminated polyester; acid |
| | | number = 30-35 (non-blooming) |
| PT 810 | Ciba-Geigy | Triglycidyl isocyanurate (TGJC) |
| PX 2FB | Nippon | Tetraethyl phosphonium |
| | Chemical | tetrafluoroborate |
| RESIFLOW ® P-67 | Estron | Acrylic flow modifier absorbed onto an inert carrier |
| | Chemical. Inc | |
| R960 TiO₂ | DuPont Ltd. | Titanium dioxide (TiO₂) |
| | (Australia) | |
| Arctic blue #3 | Shepherd Color | Inorganic blue pigment |
| | Company | |
| RO-3097 | Harcros | Iron oxide red pigment |
| | Pigments | |

Unless otherwise noted, all component amounts are expressed as parts by weight. Semicrystalline resins were prepared in accordance with the Resin Synthesis procedures recited below.

TABLE 2
(Resin A)

| Ingredient | Number of equivalents | Weight in grams |
|---|---|---|
| 1,6-Hexanediol (HD) | 1.15 | 67.85 |
| Terephthalic acid (TA) | 1.0 | 83.00 |
| Isophthalic acid (IPA) | 0.25 | 20.75 |
| Triphenylphosphite | — | 0.15 |
| (TTP) | | |
| Fascat 4100 | — | 0.08 |
| Irganox 1010 | — | 0.15 |

A resin kettle fitted with a partial condenser, total condenser, stirrer, nitrogen inlet and temperature controller was charged with 67.85 grams (g) of 1,6-hexanediol and 0.15 g of triphenylphosphite. The mixture was heated while stirring and maintaining nitrogen flow of about 25 to 30 milliliters per minute (ml/min.). When the 1,6-hexanediol has melted, 83.00 g of terephthalic acid and 0.08 g of Fascat 4100 were added to the mixture, and heating continued. When the temperature reached 195° C., water of esterification began condensing and collecting in the receiving flask. The temperature of the reactants rose slowly to about 240° C. as the esterification reaction progressed. When about 90% of the distillate had been collected, nitrogen was purged at a rate of 200 to 300 ml/min. During the distillate collection, the acid value of the mixture was monitored. When the acid value dropped below 5, isophthalic acid and Irganox 1010 were added to the mixture, and the temperature was maintained at 235° C. After heating the mixture for an additional 2 to 3 hours, the entire system was placed under reduced pressure for another 1 to 2 hours. The polyester resin A formed in the kettle was then discharged, cooled, and ground into flakes.

TABLE 3

| | Resin B | | Resin C | |
|---|---|---|---|---|
| | Number of | Weight in | Number of | Weight in |
| Ingredient | equivalents | grams | equivalents | grams |
| 1,6-Hexanediol | 1.15 | 67.85 | 1.07 | 63.2 |
| (HD) | | | | |
| Terephthalic acid | 1.0 | 83.00 | 1.0 | 83.0 |
| (TA) | | | | |
| Trimellitic | 0.43 | 27.52 | 0.2 | 12.8 |
| anhydride (TMA) | | | | |
| Triphenylphosphite | — | 0.15 | 5 | |
| (TPP) | | | | |
| Fascat 4100 | 13 | 0.08 | 13 | 0.08 |
| Irganox 1010 | — | 0.15 | — | 0.15 |

The reactions were carried out as described in the synthesis of polyester resin A, except that in the second stage of the reaction, (1) isophthalic acid was replaced with trimellitic anhydride; (2) the temperature was maintained at 220° C. for about 2 to 3 hours; and, (3) the resulting polyester-resins B and C were discharged without applying reduced pressure. The acid numbers of each resin were determined using Morton Powder Test Method 0049-0696 using bromothymol blue indicator (based on American Society for Testing and Materials D1639-90 (ASTM D1639-90)).

Polyester resins A, B and C exhibited the following characteristics as shown in Table 4:

TABLE 4

| Property | Resin A | Resin B | Resin C |
|---|---|---|---|
| Acid no. (mg | 41.6 | 100.6 | 55 |
| KOH/gm) | | | |
| ICI viscosity @ 200° C. | 7.5 | 6 | 25 |
| in poise | | | |
| Tm₁, Tm₂ (° C.) | 111, 126 | 96, 112.4 | 119, 131 |
| ΔH (J/gm) | 32.8 | 24.9 | 31 |
| Tg (° C.) | <20 | <20 | <20 |

Five coating powder formulations were prepared using the polyester resins A and B (see Table 5 below). The components of each formulation were bag blended and extruded using a twin screw extruder (cool/160° C., 400 revolutions per minute). Aluminum Oxide C was added in an amount of 0.2 weight % to the extrudate prior to grinding. The powder coating was then ground and screened through a 200 mesh screen to remove coarse particles. The resulting powder coating was sprayed onto 3 inch by 5 inch clean, cold rolled steel panels, commercially available as Q-panels from Q-Panel Lab Products, Cleveland, OH, and cured at 300° F. (149° C.) for 10 minutes to form a powder coating. Each powder coating possessed a film thickness of 1.8 mils to 2.2 mils (0.05 to 0.06 millimeters). Samples 1 through 5 illustrate the novel coating powders containing the amorphous and semi-crystalline polyester resins in varying amounts, while Sample 6 is a comparative example. The amounts of each component are shown in Table 5 are listed in parts per hundred of resin/cure agent.

TABLE 5

| | Sample | Sample | Sample | Sample | Sample | Sample |
|---|---|---|---|---|---|---|
| Component | 1 | 2 | 3 | 4 | 5 | 6* |
| Rohm and | 70.0 | 70.0 | 70.0 | — | 79.0 | |
| Haas′ | | | | | | |
| Carboxyl | | | | | | |
| terminated | | | | | | |
| polyester | | | | | | |
| Rohm and | — | — | — | 70.0 | — | 93.0 |
| Haas′ | | | | | | |
| Carboxyl | | | | | | |
| terminated, | | | | | | |
| non- | | | | | | |
| blooming | | | | | | |
| polyester | | | | | | |
| Polyester A | 23.0 | 17.0 | 11.5 | 23.0 | — | — |
| Polyester B | — | 6.0 | 11.5 | — | 14.0 | — |
| PT 810 | 7.0 | 7.0 | 7.5 | 7.0 | 7.5 | 7.0 |
| RESIFLOW | 1.4 | 1.4 | 1.4 | 1.4 | 1.4 | 1.4 |
| P67 | | | | | | |
| Benzoin | 0.8 | 0.8 | 0.8 | 0.8 | 0.8 | 0.8 |
| R960 TiO2 | 30.0 | 30.0 | 30.0 | 30.0 | 30.0 | 30.0 |
| PX 2FB | 1.0 | 1.0 | 1.0 | 1.0 | 1.0 | 1.0 |

*Comparative Example

For each coating powder sample the gel time, Hot Plate Melt Flow (HPMF), forward and reverse impact, MEK, 20° and 60° Gardner Gloss and coatability measurements were recorded and summarized below in Table 6.

Gel time was measured according to a modified version of ASTM Specification D-3451.14 (modified). In the modified test method, a small quantity of powder (⅛teaspoon) is dropped onto a hot plate at a given temperature, e.g. 205° C. (400° F.) and stroked with a tongue depressor until continuous and readily breakable filaments are formed when the depressor is lifted from the sample. The elapsed time for this to occur is measured in seconds and represents the gel time measurement.

In the HPMF test, a pellet of powder having a diameter of 12.7 mm and 6 mm thick is placed on a hot plate set at 375° F. (190+/−2° C.) at an inclination angle of 35°. The pellet melts and runs down the plate. The length of the flow is measured in millimeters. The distance the coating flows is dependent on the initial melt viscosity, the rate of reaction, the temperature at which the test is conducted, and the type and amount of catalyst.

Forward and reverse impact resistances were measured according to ASTM D 2794 by using a Gardner impact test model G1120.

Methyl ethyl ketone resistance (MEK resistance), a rating of solvent resistance and an indication of crosslink density, was measured as follows. A cotton swab was soaked in MEK and rubbed with moderate pressure in a back and forth stroking motion (a “double rub”) 50 times. A relative rating was given on a scale of 1-5 with a rating of 5 defined as the most solvent resistant and a rating of 1 justified when the coating can be completely removed during the process to expose bare substrate. More specifically, a rating of 5 corresponds to no rub off, 4 to slight rub off, 3 to moderate rub off, 2 to severe rub off, and 1 to complete rub through to substrate.

Gloss was measured at 20° and 60° according to a modified version of ASTM D 523 by using a BYK Gardner Micro TRI gloss meter.

Coatability was determined by visual observation.

TABLE 6

| | Sample | Sample | Sample | Sample | Sample | Sample |
|---|---|---|---|---|---|---|
| Test | 1 | 2 | 3 | 4 | 5 | 6* |
| Gel Time at | 28 | 20 | 16 | 29 | 15 | 31 |
| 400° F. (sec) | | | | | | |
| HPMF at | 100 | 30 | 24 | 105 | 20 | 82 |
| 375° F. | | | | | | |
| (mm) | | | | | | |
| Impact | 160/160 | 160/160 | 160/160 | 160/160 | 160/160 | 160/160 |
| (forward/ | | | | | | |
| reverse) | | | | | | |
| MEK(50 | 5 | 5 | 5 | 5 | 5 | 4-5 |
| double | | | | | | |
| rubs) | | | | | | |
| Gloss | 81/95 | 65/95 | 55/90 | 83.5/ | — | 85/96 |
| (20 /60) | | | | 96.5 | | |
| Coatability⁶ | Heavy | Open | Open | Some | Very | Moderate |
| | Orange | Texture | Texture | Orange | Fine | orange |
| | Peel | | | Peel | Texture | peel |

*Comparative Example

Based upon the test results shown in Table 6, Sample 1 powder coating exhibited better overall properties than the powder coatings of Samples 2, 3 and 5. Because of the presence of Polyester B, a semi-crystalline polyester resin having a higher acid functionality, i.e., approximately 4, in Samples 2, 3 and 5, their powder coatings not only exhibited lower gel times, HPMF values, and gloss values, but also exhibited an open texture indicating microtexture formation. An open texture will always prevent a powder coating from achieving a high gloss. In the case of Sample 1, despite exhibiting a heavy orange peel, Sample 1 still provides a high gloss finish. The powder coatings of Samples 1 and 4 possessed nearly identical properties due to their relatively identical formulations; the difference being the substitution of the polyester present in Sample 1, with a non-blooming carboxyl terminated polyester resin, present in Sample 4. For this reason, Sample 4 exhibited only some orange peel due to the presence of a non-blooming polyester resin in contrast to the heavy orange peel exhibited by Sample 1. However, both Samples 1 and 4 demonstrate that good low temperature cure was achieved, and only a difference in appearance was demonstrated, when adding a semi-crystalline polyester resin into a coating powder formulation.

The powder coatings of Samples 4, 5 and 6 were cured at 275° F. (135° C.) for 15 minutes. The forward and reverse impact, MEK, 20° and 60° Gardner Gloss and coatability measurements were recorded and are summarized below in Table 7. A gloss reading was not obtained for Sample 5 because it possessed a fine texture.

TABLE 7

| Test | Sample 4 | Sample 5 | Sample 6* |
|---|---|---|---|
| Impact (F/R) in-lb | 160/160 | 160 | Fail |
| MEK (50 double | 3-4 | 4-5 | 3-4 |
| rubs) | | | |
| Gloss (20 /60) | 81/96 | — | 84/96 |
| Coatability | Some Orange Peel | Fine Texture | Moderate |
| | | | Orange Peel |

*Comparative Example

When comparing Sample 4 (and Sample 5) to Sample 6, employing semi-crystalline resins A or B in the final coating powder not only enhance the resulting powder coating from an appearance standpoint but also strengthen and improve the powder coating's performance.

An additional sample and control were prepared to show that the inclusion of Resin A improves the impact resistance of an opaque white coating (TiO₂ loading>40 phr). Coating powders were prepared as previously described. Steel Q-panels were coated at 2.5-3.5 mils via electrostatic spray and cured at 300° F. for 15 minutes.

TABLE 8

| Ingredient | Sample 7* | Sample 8 |
|---|---|---|
| Rohm and Haas' carboxyl | 93.0 | 73.0 |
| terminated, non-blooming | | |
| polyester | | |
| PT-810 | 7.0 | 7.0 |
| Resin A | — | 20 |
| RESIFLOW P67 | 1.5 | |
| Benzoin | 0.8 | |
| R-960 | 45.0 | |
| Artic Blue #3 | 0.17 | |
| RO-3097 | 0.015 | 0.015 |
| PX-2FB | 1.0 | 1.0 |

*Comparative example

TABLE 9

| Test | Sample 7* | Sample 8 |
|---|---|---|
| Gel time at 400° F. (sec) | 52 | 56 |
| HPMF at 375° F. (mm) | 54 | 58 |
| Impact (forward/reverse) | 40/20 | 160/120 |
| MEK (50 double rubs) | 5 | 5 |
| Gloss (60°) | 95.3 | 98.2 |
| Coatability | Moderate orange peel | Moderate orange peel |

For all practical purposes, the properties of Sample 7 and Sample 8 are identical except for the impact resistance. Both coatings show excellent cure properties as indicated by MEK. However, Sample 8, which contains semi-crystalline Resin A, exhibited much better impact resistance.

1. A coating powder, comprising:
a polyester resin composition comprising:
an amorphous carboxylic acid functional polyester resin in an amount of 75 to 90 parts per hundred parts by weight of the total polyester resin composition, and
a semi-crystalline polyester resin in an amount of 10 to 25 parts per hundred parts by weight of the total polyester resin composition, wherein the semi-crystalline polyester resin provides the coating powder with a total cure time of 5 to 20 minutes;
an epoxy-functional curing agent; and
a catalyst.

2. The coating powder of claim 1, wherein the amorphous resin is non-blooming.

3. The coating powder of claim 1, wherein the semicrystalline resin is formed from a polyol and a polycarboxylic acid wherein the polycarboxylic acid comprises 10 to 50 phr of an asymmetrically substituted aromatic polyacid, ester, acid halide, anhydride, or a mixture thereof.

4. The coating powder of claim 1, wherein the epoxy-functional curing agent is TGIC.

5. The coating powder of claim 1, wherein the catalyst is a tetra-substituted ammonium halide salt, a tetra-substituted phosphonium halide salt a tetra-substituted phosphonium tetra-substituted borate salt, a tetra-substituted arsonium tetra-substituted borate salt, a tetra-substituted ammonium tetra-substituted borate salt, an imidazole tetra-substituted borate salt, or a mixture comprising at least one of the foregoing salts.

6. A coating powder, comprising:
a polyester resin composition comprising:
an amorphous carboxylic acid functional polyester resin in an amount of 75 to 90 parts per hundred parts by weight of the total polyester resin composition, and
a semi-crystalline polyester resin in an amount of 10 to 25 parts per hundred parts by weight of the total polyester resin composition, wherein the semicrystalline resin is formed from a polyol and a polycarboxylic acid, wherein the polycarboxylic acid comprises 10 to 50 phr of an asymmetrically substituted aromatic polyacid or derivative thereof;
triglycidyl isocyanurate; and
tetraethyl phosphonium tetrafluoroborate in an amount of 0.1 to 5 parts per hundred parts of total resin by weight.

7. A method for coating an article, comprising:
contacting the article with a particulate coating powder to form a powder coating layer, wherein the particulate coating powder comprises a polyester resin comprising an amorphous carboxylic acid functional polyester resin in an amount of 75 to 90 parts per hundred parts by weight of the total polyester resin composition, and a semi-crystalline polyester resin in an amount of 10 to 25 parts per hundred parts by weight of the total polyester resin composition, wherein the semi-crystalline polyester resin provides the coating powder with a total cure time of 5 to 20 minutes, an epoxy-functional compound, and a catalyst;
fusing the coating powder layer to form a powder coating; and
curing the powder coating at a temperature and for a time effective to form a smooth coating.

8. The method of claim 7, wherein fusing and curing is at a temperature of 200 to 350° F.

9. The method of claim 7, wherein contacting is by electrostatic spraying, corona-discharge, tribocharging, fluidized bed, or a combination thereof.

10. The method of claim 7, wherein the article comprises a substrate selected from the group consisting of wood, hardwood, hard board, laminated bamboo, wood composites, particle board, electrically conductive particle board, high density fiber board, medium density fiber board, low density fiber board, masonite board, laminated bamboo, acrylonitrile butadiene styrene copolymers, polyphenylene oxide copolymers, sheet molded components, polyolefins, polycarbonates, acrylics, nylons paper, cardboard, metal, glass, steel, ceramic, carbon, graphite and combinations thereof.

11. A powder coated article manufactured according to the method of claim 7.
